(19) United States
(12) Patent Application Publication
(10) Pub. No.: US 2026/0138849 A1
(43) Pub. Date: May 21, 2026

(54) SYSTEM AND METHOD FOR DETERMINING ELEVATOR CAR MOVEMENT

(71) Applicant: Argus Elevator LLC, Kennesaw, GA (US)

(72) Inventor: Omar Gil-Arias, Atlanta, GA (US)

(21) Appl. No.: 19/391,775

(22) Filed: Nov. 17, 2025

Related U.S. Application Data
(60) Provisional application No. 63/721,822, filed on Nov. 18, 2024.

(51) Int. Cl. B66B 5/00; B66B 1/30; B66B 1/34; B66B 1/36; B66B 5/02

(52) U.S. Cl. CPC B66B 5/0031; B66B 1/30; B66B 1/3461; B66B 1/36; B66B 5/02

(57) ABSTRACT

An unintended car movement (UCM) detection system, installable onto a legacy elevator system in which an elevator car is moveable responsive to rotation of a drive sheave, includes a plurality of readable tape segments affixed directly to the drive sheave in a discontinuous pattern, each readable tape segment defining an upper surface bearing readable information capable of indicating a rotational position of the drive sheave, a reading sensor positioned in operable proximity to the discontinuous pattern, the reading sensor configured to read the information from the discontinuous pattern and to transmit read information as rotational data to a reading sensor output, and a logic system operably communicating with both the reading sensor output and with at least one other component of the legacy elevator system, the logic system configured to combine the rotational data and elevator system data to determine whether the elevator car is undergoing unintended movement.

### CROSS-REFERENCE TO RELATED APPLICATION

This application claims the benefit of U.S. Provisional Patent Application Ser. No. 63/721,822, filed Nov. 18, 2024.

### TECHNICAL FIELD

### Field of Use

This disclosure relates to movement detection systems and methods used in elevator systems. More specifically, this disclosure relates to a system and method for inexpensively detecting whether an elevator car is undergoing Unintended Car Movement (UCM) within a hoistway of a legacy elevator system, i.e., an elevator system constructed before the imposition of any regulations requiring UCM detection for new elevator installations.

### Related Art

FIG. 1 illustrates an exemplary conventional elevator system 10 comprising an elevator car 12 vertically moveable within a hoistway 14, the car 12 suspended by a first flexible support 16 such as a cable, rope, or belt. The car 12 can be provided with a first pair of roller guides 15a, b and an opposed second set of roller guides 17a, b. The first pair of roller guides 15a, b can engage a first rail 13a mounted in the hoistway 14, and the second pair of roller guides 17a, b can engage a second rail 13b mounted in the hoistway 14. The flexible support 16 is partially wound around a driving sheave 18 that is driven by a main body 20 of an elevator machine 22 located within a machine room 24. The elevator machine 22 generates force that rotates the driving sheave 18, thus causing the first flexible support 16 to either pull or lower the car 12, depending on the direction of rotation of the driving sheave 18. The driving sheave 18 can be mounted to a drive shaft 19, such that the driving sheave 18 rotates as the drive shaft 19 is rotated by a motor of the elevator machine 22. The first flexible support 16 can also be partially wound around a deflecting sheave 26. Also shown located within machine room 24 is a speed governor 28 comprising a speed governor sheave 30 rotatably supported by a main body 32.

Braking of the elevator car 12 can be accomplished by any of the alternative types of braking mechanisms shown in FIG. 1, namely, a rope brake (also called a rope gripper) 35a, a sheave brake (also called a disc brake) 35b, and a rail brake 35c. The rope brake (rope gripper) 35a, which is the most common type of brake used to prevent or ameliorate UCM, gets mounted in a fixed place, usually in the machine room 24 next to the elevator machine 22 or at another place in the hoistway 14. The sheave (disc) brake 35b consists of a disk or rotating surface and a braking pad that gets mounted on the drive shaft 19 or directly to the driving sheave 18, The rail brake 35c, which is the least common type of brake used for UCM, can be mounted on top of the elevator car 12 and consists of a mechanism with opposed pads that respectively grab the rails 13a, b guiding the elevator car 12. Examples of such rail brakes 35c can be found in European Patent Application No. EP 1,749,780 to Mitsubishi Denki Kabushiki Kaisha, published on Feb. 7, 2007.

A second flexible support 34 (such as a cable) has one end that is attached to the rail brakes 35c located atop the car 12. The rail brakes 35c function as an emergency brake that, when in a braking state, mechanically prevents the car 12 from moving, regardless of the state of any other elevator component. The second flexible support 34 extends upwardly from the braking mechanism 35 to be partially wrapped around the speed governor sheave 30, then extends downwardly to be partially wrapped around a tensioning sheave 36 of a tensioning apparatus 38 affixed to a guide rail 40, and then extending upwardly again such that an opposite end of the second flexible support 34 is also attached to the rail brakes 35c. The tensioning apparatus 38 can also be provided with a tensioning weight 42 mounted to a pivoting arm 44, as well as an encoder 46 that monitors the rotation of the tensioning sheave 36. The encoder 46 electrically communicates with an elevator controller 48 via a wire 47, such that the elevator controller 48 can detect the distance moved by the car 12 based on the information received from the encoder 46. The elevator controller 48 can be configured in the same manner as the elevator controller referenced at numeral 102 in U.S. Pat. No. 10,766,745, titled “Universal and Software-Configurable Elevator Door Monitor,” the disclosure of which is expressly incorporated by reference herein in its entirety. Conventional elevator systems can vary from the arrangement illustrated in FIG. 1; for instance, an encoder can monitor the rotation of the drive sheave 18 instead of the tensioning sheave 36.

UCM can present safety problems within an elevator system. For example, if a person is about to enter or leave the car, and the car starts to move up or down, the person can fall. Worse yet, the person can be trapped between the moving car and the wall. Many jurisdictions therefore have long required new elevator installations to possess UCM detection capability. In addition, some jurisdictions are starting to retroactively require UCM detection capability for legacy elevator systems.

Encoder-based position determination systems can be retrofitted onto legacy elevator systems. Encoders were first used to facilitate the speed and torque control of the machine responsible for the car movement. They are also used to determine the speed and position of the car for a better riding experience. There are two types of encoders: absolute and incremental. Absolute encoders provide absolute position and velocity information, while incremental encoders provide relative information. Both types of encoders can be used to determine the absolute position and velocity of an elevator car, but incremental encoders require another signal to indicate the elevator car position. For example, a signal indicating that the elevator car is at the first floor of a building can be used by an elevator controller to correlate the position of the elevator car to an incremental count of the incremental encoder existing at the moment the elevator car is at that position, thereby providing an absolute position tracking capability for the incremental encoder-based system.

An incremental encoder can be installed onto a drive sheave of the elevator system. One example of this is taught in European Application Publication No. EP 1,719,780 to Mitsubishi, FIG. 31 and associated specification text of which teaches mounting an encoder onto a governor sheave. The encoder outputs a rotational position signal based on the rotational position of the sheave. A car position calculating circuit determines elevator car position based on the rotational position signal from the encoder. The calculating circuit then outputs the calculated car position to both a control device and a slippage determining device. Incremental encoders can also be mounted to tensioning sheaves, as taught in U.S. Pat. No. 7,763,763 to Kawakami. Still further, incremental encoders can be mounted to a guide roller in a pair of rollers that contact a guide rail as part of a speed detection device, as taught in Japanese Patent Publication No. JP2013095526 to Hitachi Ltd., and in U.S. Patent Application Publication No. 2018/0162693 to Hu. Installation of elevator systems based upon incremental encoders has proven to be highly labor-intensive and therefore very expensive. Many incremental encoder systems require operably attaching a rotatable shaft in the encoder to a drive shaft or sheave. This requires precise alignment in order to accurately correlate the rotation of the encoder shaft to the rotation of the drive shaft or sheave. Additionally, many encoder systems have internal moving parts and optical components that are inherently less robust than a magnetic based sensor.

Contemporary elevator systems possess absolute encoders that give absolute speed and position of an elevator car, such as the camera-based car motion sensor in an Absolute Positioning System sold by CEDES AG. Although such contemporary systems can assess absolute speed and position of an elevator car, such systems provide the same type of information regardless of whether the car movement is intended or unintended. None of the absolute positioning systems can detect UCM on their own; they only provide data about the car's position, speed, and acceleration. To determine whether the movement is unintended, additional information from other elevator signals and a logic system for interpretation are required. Absolute positioning systems are nevertheless frequently used for UCM retrofits because detecting car motion is the first step in identifying UCM. To distinguish intended from unintended motion, the position/velocity data must be continuously compared with other control signals. A logic system is needed to monitor these inputs, make the UCM determination, and, if necessary, trigger the emergency brake and interrupt other circuits. Further, such contemporary systems are relatively expensive and can present installation complications. For example, an ELGO Batscale (AG) manual requires exact alignment between a sensor head and magnetic tape in order to obtain accurate readings from scanning the tape with the sensor. The effort to attain exact alignment is not only time consuming, but also is fraught with the possibility of human error that can result in a failure to attain the desired alignment.

Another type of an Absolute Positioning System is disclosed in U.S. Pat. No. 8,596,420 to Korhonen et al., which discloses a system employing a reading sensor that reads data from a continuous band of magnetic tape mounted onto a circumferential surface of an elevator system rotor, the magnetic tape continuity evident from a “mounting surface 11 [that] forms a circle around the rotational axis 7 of the rotor” (4:34-35) and the attachment of a magnetic band 4 to “the circumference of the rotor 3.” (4:30-32). Attaching a continuous band of magnetic tape to a rotor or sheave presents certain challenges. Precision is required when positioning the continuous tape on the circumferential surface on the rotor to ensure that it does not assume a warped or skewed position on the surface, which could lead to inaccurate readings by the reading sensor when the rotor with the tape rotates. Additionally, differently sized rolls of magnetic tape must be purchased for differently sized rotors.

### SUMMARY

In situations where a legacy elevator system must be retrofitted for UCM detection purposes, the owner of such a system must pay for technology that the owner might not otherwise necessarily need, i.e., an Absolute Positioning System or other sensors like the encoders discussed above. There is therefore a need in the industry to provide a UCM detection system that can be inexpensively retrofitted onto a legacy elevator system in situations where an elevator owner does not require the system to provide very accurate speed and positioning of an elevator car.

It is also desirable to devise a UCM detection system that can overcome the difficulties and drawbacks discussed above with regard to encoder-based UCM monitoring systems.

It has been found that to adequately detect UCM, a detection system need not employ a continuous readable band or tape, nor need it otherwise employ Absolute Positioning System technology. Instead, readable tape can be applied as a plurality of readable tape segments onto an outer surface of a drive sheave or rotor in a discontinuous pattern that only roughly approximates a circle. “Readable tape,” as used herein means any kind of tape that, upon motion of an elevator system component to which the tape is adhered, enables a reading sensor positioned in proximity to the moving readable tape to provide information indicating motion or, alternatively, no motion, of an elevator car Thus, although magnetic tape and sensors are employed as exemplary elements of the disclosed UCM detection system, as discussed in further detail herein, the disclosed system need not be restricted to magnetic tape and reading sensors. For example, the disclosed system can employ other types of readable tape with corresponding optical sensors that can provide motion/no motion information of an elevator car. A few such reading sensors can be of the following types: photo sensor, laser, and camera-based. In addition to those reading sensor examples, an inductive sensor could be used, in which event readable tape segments would take the form of linear segments of metal with teeth, similar to a rack, in a rack and pinion system. The inductive sensor would be mounted to detect the signals generated by the metal teeth of the rack as they pass in front of the inductive sensor.

“Discontinuous,” as used herein with respect to a circumferential mounting surface of a drive sheave, means that the ends of consecutive mounted segments can be spaced apart from one another. As used herein with respect to an axial mounting surface of a drive sheave, “discontinuous” means non-circular, such that not all points located upon respective centerlines of the mounted readable tape segments are equidistant from the center (or axis of rotation) of the drive sheave. This definition encompasses alternative arrangements in which: (i) ends of all consecutive mounted readable tape segments in the plurality of mounted readable tape segments are spaced apart from one another; (ii) ends of all consecutive mounted readable tape segments in the plurality of mounted readable tape segments touch one another; and (iii) some consecutive mounted readable tape segments touch one another, while other consecutive mounted segments in the same arrangement do not.

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is an unintended car movement (UCM) detection system, the UCM detection system installable onto a legacy elevator system in which an elevator car is moveable responsive to rotation of a drive sheave, the UCM detection system comprising a plurality of readable tape segments affixed directly to an outer surface of the drive sheave in a discontinuous pattern, each readable tape segment defining a lower surface adhering to the outer surface of the drive sheave and an upper surface bearing readable information capable of indicating a rotational position of the drive sheave; a reading sensor positioned in operable proximity to the discontinuous pattern, the reading sensor configured to read the information from each of the plurality of readable tape segments in the discontinuous pattern and to transmit read information as rotational data to an output of the reading sensor; and a logic system configured to operably communicate with the output of the reading sensor and with at least one other component of the legacy elevator system, the at least one other component configurable to send elevator system data to the logic system.

In a further aspect, disclosed is a method of detecting unintended car movement (UCM) in a legacy elevator system, the UCM causing rotation of a drive sheave in the legacy elevator system, the method comprising the steps of, when the drive sheave is in a stationary condition, affixing a plurality of readable tape segments directly to an outer surface of the drive sheave in a discontinuous pattern, each readable tape segment in the discontinuous pattern defining a lower surface adhering to the outer surface of the drive sheave and an upper surface bearing readable information capable of indicating a rotational position of the drive sheave; positioning a reading sensor in operable proximity to the discontinuous pattern; and reading, with the reading sensor, the readable information from the discontinuous pattern when the drive sheave rotates. The method can additionally include the steps of transmitting read information as rotational data to an output of the reading sensor; receiving, with a logic system operably communicating with the output of the reading sensor, the rotational data from the reading sensor; receiving, with the logic system, elevator system data from the at least one other component of the legacy elevator system; combining, with the logic system, the rotational data and the elevator system data; and based on a combination of the rotational data with the elevator system data, determining whether the elevator car is undergoing unintended movement.

Various implementations described in the present disclosure can comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a schematic view of a conventional elevator system.

FIG. 2 is a combined perspective and schematic view of an unintended car movement (UCM) detection system constructed in accordance with an aspect of the current disclosure, showing a plurality of readable tape segments in exploded view in relation to a circumferential mounting surface of a drive sheave.

FIG. 3A is a side view of a readable tape segment used in a UCM system constructed in accordance with an aspect of the current disclosure.

FIG. 3B is top view of a readable tape segment used in a UCM system constructed in accordance with an aspect of the current disclosure.

FIG. 4A is a front view of the axial surface of the drive sheave shown in FIG. 1, to which has been affixed a plurality of readable tape segments arranged in a hexagonal discontinuous pattern.

FIG. 4B is a front view illustrating an alternative method of forming a gap between two of the readable tape segments illustrated in FIG. 4A.

FIG. 5 is a front view of the axial surface of the drive sheave shown in FIG. 1, to which has been affixed a plurality of readable tape segments arranged in an octagonal discontinuous pattern.

FIG. 6 is a flow chart illustrating method steps that can be executed in an exemplary method performed in accordance with aspects of the current disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

To simplify the description of various elements disclosed herein, the conventions of “top,” “bottom,” “side,” “upper,” “lower,” “horizontal,” and/or “vertical” may be referenced. Unless stated otherwise, “top” describes that side of the system or component that is facing upward and “bottom” is that side of the system or component that is opposite or distal the top of the system or component and is facing downward. Unless stated otherwise, “side” describes that an end or direction of the system or component facing in horizontal direction. “Horizontal” or “horizontal orientation” describes that which is in a plane aligned with the horizon. “Vertical” or “vertical orientation” describes that which is in a plane that is angled at 90 degrees to the horizontal.

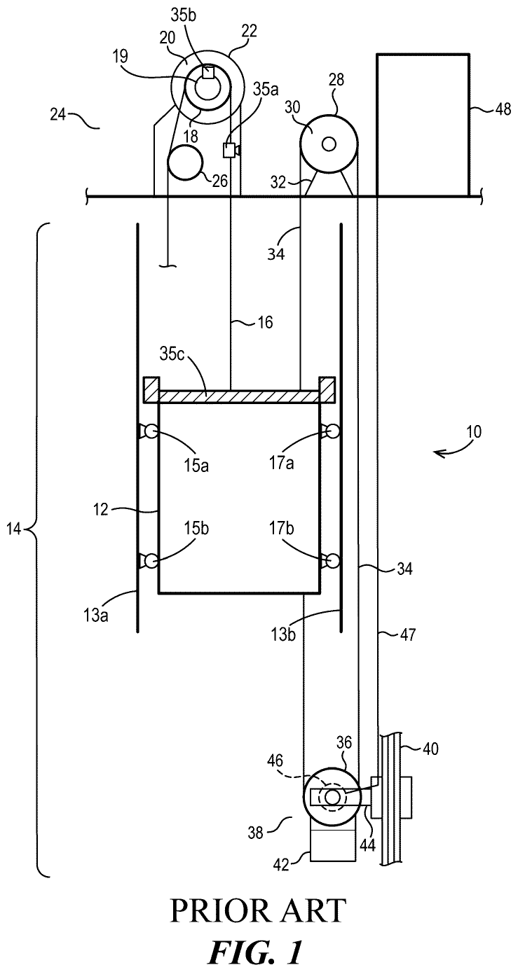

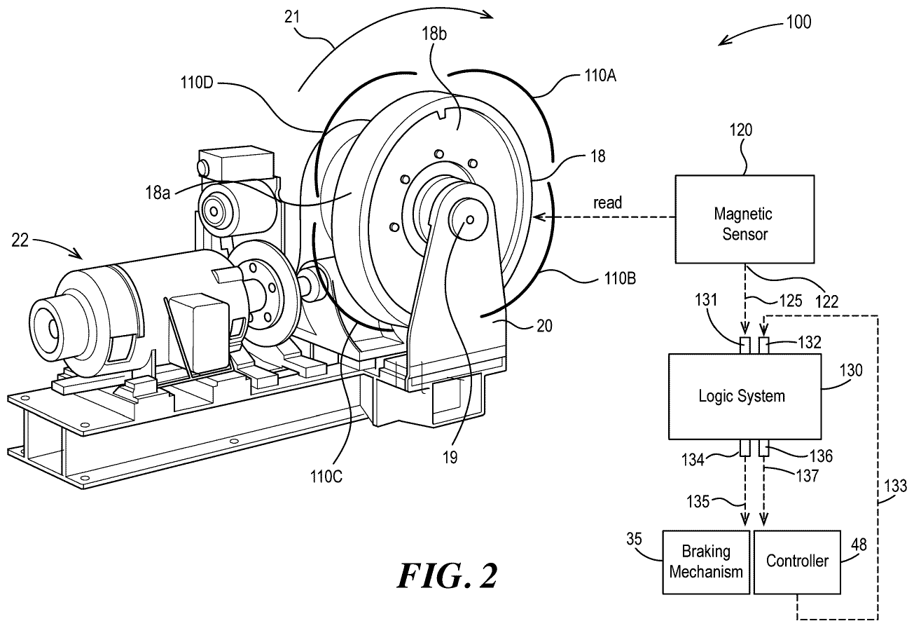

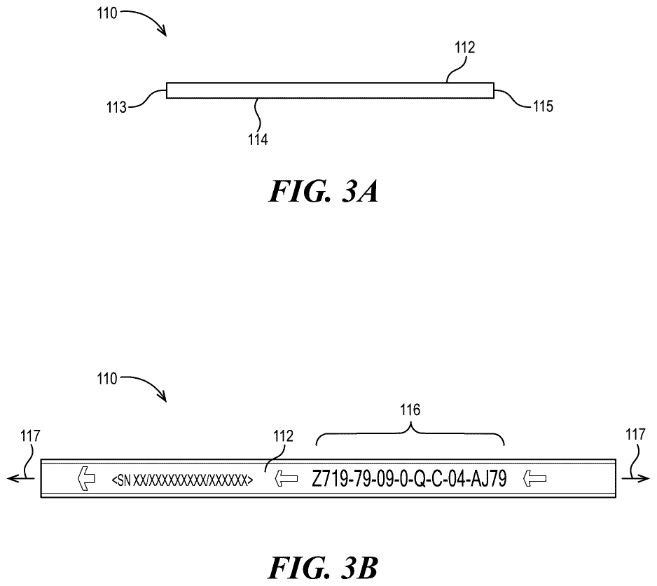

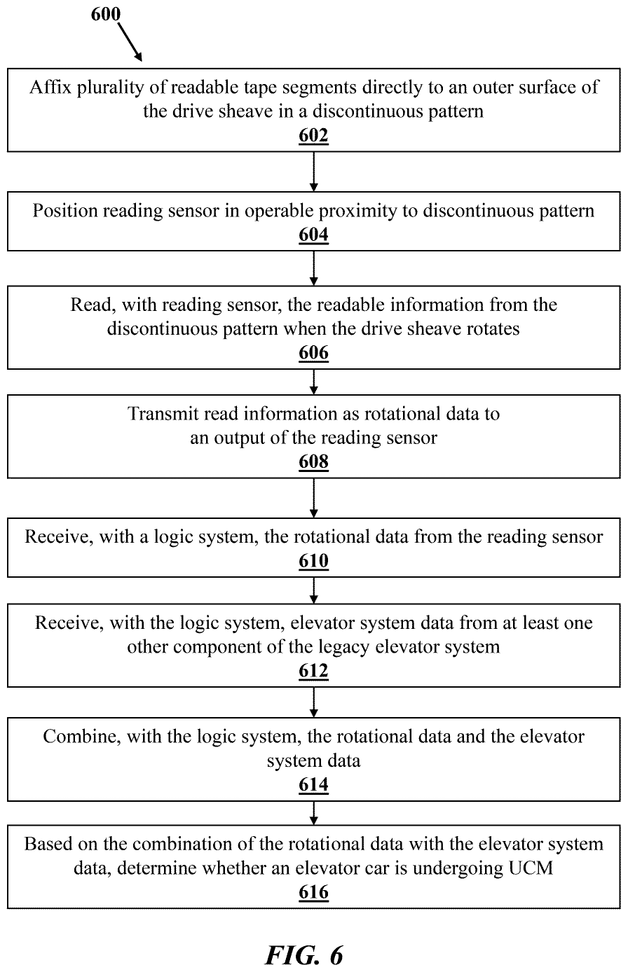

Referring to FIGS. 2, 3A, 3B, and 6, FIG. 2 shows a UCM detection system 100 constructed in accordance with an aspect of the current disclosure, showing a plurality of readable tape segments 110A-D in exploded view in relation to a circumferential mounting surface 18a of the drive sheave 18 shown in the elevator system 10 (FIG. 1). It is to be understood that a legacy elevator system equipped with system 100 need not include all elements shown in FIG. 1. For instance, system 100 eliminates the need for the encoder 46 of FIG. 1. Each readable tape segment 110A-D has a lower surface 114 bearing an adhesive (not shown) and is affixed directly to the circumferential mounting surface 18a (FIG. 6 step 602 of method 600). The word “directly,” as used herein, means that system 100 excludes use of any element that could be situated between any readable tape segment and an outer surface of the drive sheave 18. As mounted to the circumferential mounting surface 18a, consecutive readable tape segments in the plurality of readable tape segments 110A-D are spaced from one another to form a discontinuous pattern. Thus, segment 110A is spaced from segment 110B; segment 110B is spaced from 110C; segment 110C is spaced from segment 110D; and segment 110D is spaced from segment 110A. As best exemplified in FIG. 3B, each readable tape segment 110 defines an upper surface 112 bearing readable information or indicia 116 indicating a rotational position of the drive sheave 18. Each readable tape segment 110 can be cut from a roll of, for example, conventional magnetic tape having the features illustrated in FIGS. 3A and 3B. Referring to both FIGS. 3A and 3B, each readable tape segment 110 also defines a first end 113, an opposed second end 115, and a centerline 117 comprised of midpoints along the width of the readable tape segment 110.

Referring to FIGS. 2 and 6, a reading sensor 120 is positioned in operable proximity to the discontinuous pattern of readable tape segments 110A-D (FIG. 6 step 604), meaning that the reading sensor 120 is positioned substantially perpendicularly to a line tangent to the circumferential surface 18a of the drive sheave 18, and that the reading sensor 120 is sufficiently close to the circumferential surface 18a to read each mounted readable tape segment 110A-D when the drive sheave 18 rotates such as in the direction indicated by arrow 21. The reading sensor 120 is configured to read the information from the discontinuous pattern of mounted readable tape segments 110A-D (FIG. 6 step 606) and to transmit read information as rotational data to an output 122 of the reading sensor 120 (FIG. 6 step 608). If the readable tape segments 110A-D each take the form of the magnetic tape segment illustrated in FIG. 3B, then the reading sensor 120 would be a magnetic sensor.

A logic system 130 is configured to operably communicate with the output 122 of the reading sensor 120 in the manner herein described. Examples of the logic system 130 include, but are not limited to, one or more processing cores and/or components thereof, such as Data Processing Units (DPUs), Artificial Intelligence Accelerators (AIAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like. In addition, the logic system 130 can include memory. The logic system 130 also operably communicates with one or more other components of the elevator system 10 (i.e., one or more elevator system components other than the reading sensor 120) that can be configured to send at least one signal to the logic system 130 that the logic system 130 can use to determine motion status the elevator car 12. In particular, the logic system 130 can further comprise: (a) at least: a first logic system input 131 through which the logic system 130 is configured to receive and monitor a first input signal 125 from the reading sensor 120 (or from another type of sensor that can substitute for the reading sensor 120), and (b) a second logic system input 132 through which the logic system 130 is configured to receive a second input signal 133 from the elevator controller 48. The logic system 130 can also further comprise at least: (a) a first logic system output 134 through which the logic system 130 is configured to send a first output signal 135 that controls the braking mechanism 35 (the “35” collectively referring to the alternative braking mechanisms 35a, b, c discussed above with regard to FIG. 1) to mechanically stop the elevator car 12 (FIG. 1) from moving, and (b) a second logic system output 136 through which the logic system 130 is configured to send a second output signal 137 that interrupts one or more circuits within the elevator controller 48 to prevent the elevator car 12 from running electrically. With such a configuration of the UCM detection system 100, the logic system 130 can be configured to receive the rotational data from the output 122 of the reading sensor 120 (FIG. 6 step 610), to receive elevator system data from the one or more other components of the elevator system 10 (FIG. 6 step 612), and to combine such elevator system data with the rotational data received from the reading sensor 120 (FIG. 6 step 614) to determine motion status of the elevator car 12, and to determine whether the elevator car 12 is undergoing UCM (FIG. 6 step 616). In some cases, the absence of component data can help the logic system 130 assess whether UCM exists. For example, if the logic system 130 receives rotational data from the reading sensor 120 indicating that the drive sheave 18 is rotating, but is not also receiving a signal from the elevator controller 48 that the elevator machine 22 has been turned on, then the logic system 130 can determine that a UCM event has occurred. In some embodiments, the logic system 130 can be provided with software permitting user input and UCM monitoring via a graphical user interface (GUI) (not shown). Such a GUI can be configured in a manner similar to the GUI disclosed in U.S. Pat. No. 10,766,745, already incorporated herein by reference in its entirety, except that the logic system 130 would run different software from that disclosed in said patent. The GUI of the logic system 130 can show the status of all the input signals and outputs. The GUI of the logic system 130 allows for configuration of the inputs and outputs in the same way as that disclosed in said patent.

Advantageously, the UCM detection system 100 allows for the readable tape segments 110 to form a discontinuous pattern on the drive sheave 18 because the only characteristic being detected by the UCM detection system 100 is whether the elevator car 12 (FIG. 1) is undergoing motion. Neither the specific position nor speed of the elevator car 12 have to be determined beyond a reasonable level of precision. If the readable tape segments 110, as mounted on the drive sheave 18, were to form a perfect circle, and its embedded magnets were evenly spaced, the reading sensor 120 would emit the same number of pulses per degree of circular motion across the entire circumference of the drive sheave 18. In this scenario, if the magnets embedded in the readable tape segments 110 are separated by 2 mm, for example, the reading sensor 120 would generate a pulse every 2 mm. The logic system 130 could then determine a state of motion or no motion by counting pulses within a given time frame. For example, the logic system 130 could use a 0.5 s time frame and repeatedly count the number of pulses within consecutive times frames of the same length, providing a logic value (motion or no motion) every 0.5 s. For a given drive sheave speed with the mounted readable tape segments 110 forming a perfect circle, a given number of pulses would be generated, regardless of the portion of the drive sheave 18 passing by the reading sensor 120. However, when using straight segments of mounted magnetic tape 110 that do not form a perfect circular shape, the discontinuity between the segments 110 would result in a different number of pulses per time frame than with a perfectly circular shape formed by the mounted readable tape segments 110. Yet, information about the state of motion/no motion can still be determined. In this example, the worst-case scenario would be if the gap between mounted readable tape segments 110 were so large that the reading sensor 120 would be unable to generate pulses for an angular movement corresponding to a large displacement of the elevator car 12.

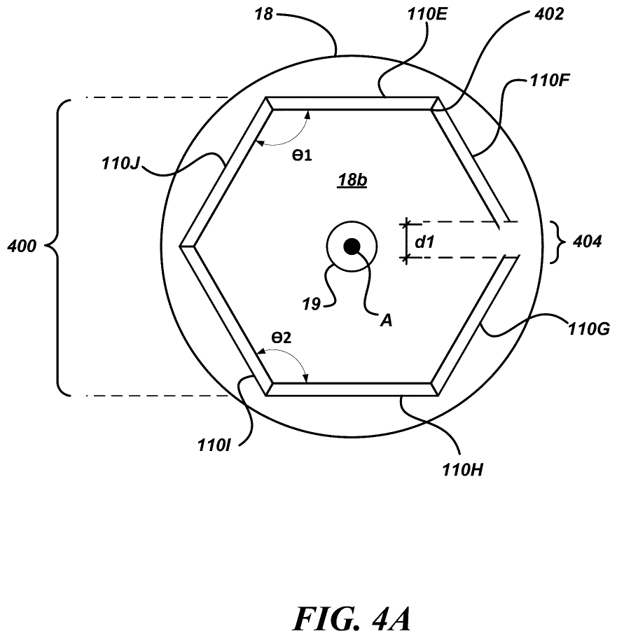

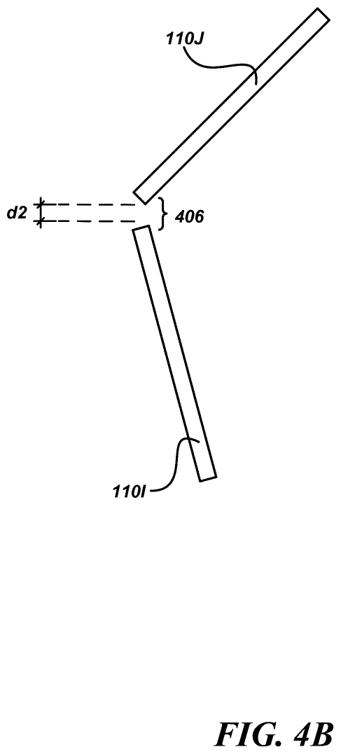

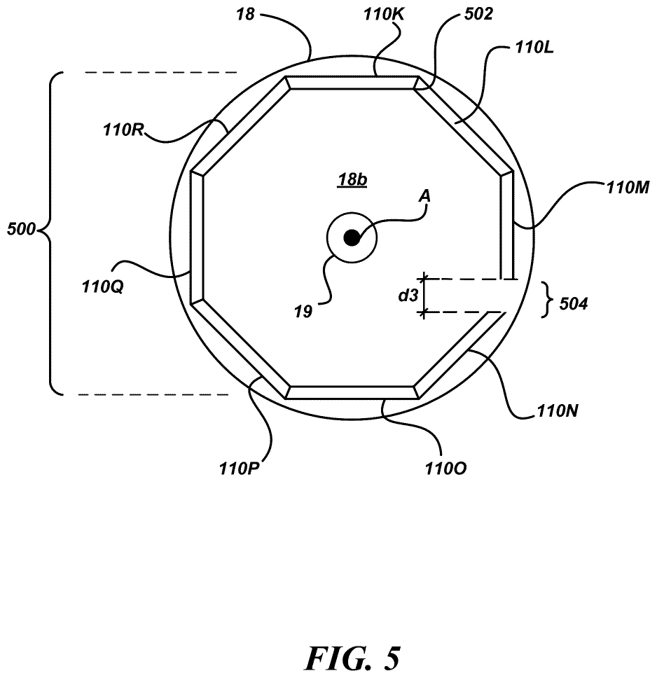

Referring to examples of patterns illustrated in FIGS. 4A and 5, the readable tape segments 110 can be directly mounted to an axial surface 18b of the drive sheave 18, rather than to the circumferential surface 18a (FIG. 2). In such an instance, the reading sensor 120 (FIG. 2) would be positioned substantially perpendicularly to axial surface 18b (in other words, substantially parallel to the axis of rotation A of the drive shaft 19 on which the drive sheave 18 is mounted), sufficiently close to the axial surface 18b to read each mounted readable tape segment 110 when the drive sheave 18 rotates.

FIG. 4A depicts a front view of the axial surface 18b of the drive sheave shown 18, to which has been affixed a plurality of readable tape segments 110E-J arranged in a hexagonal discontinuous pattern 400 having interior angles such as θ₁ between segments 110E and 100J, and θ₂ between segments 110H and 110I. If pattern 400 forms the perfect hexagon shown, then all of its interior angles (including θ₁ and θ₂) each equal 120°. As an example, the discontinuous pattern 400 shows all ends of consecutive mounted readable tape segments 110E-J touching one another at joints such as at 402, except that a gap 404 measuring distance d1 is formed between the ends of consecutive readable tape segments 110F and 110G. In the example of FIG. 4A, the segment 110F has been cut to a shorter length than the length of segment 110G to create the gap 402. In this manner, gap 402 has been formed without altering the magnitude of any interior angle of the hexagon formed by pattern 400. Thus, each interior angle of the pattern 400 remains 120°, if the pattern 400 otherwise forms a perfect hexagon. Many variations of discontinuous pattern 400 are encompassed within the present disclosure. For example, discontinuous pattern 400 can be formed without gaps, with gaps between every consecutive readable tape segment 110E-J, or with more than one such gap but with one or more consecutive readable tape segments 110E-J touching to form a joint such as at 402.

FIG. 4B illustrates an alternative manner of forming a gap between two readable tape segments. In this example, a gap 406 of magnitude d2 has been formed between readable tape segments 110I and 110J instead of either of the readable tape segments 110I, J being cut to a reduced length. Instead, the interior angle θ₁ and/or θ₂ of pattern 400 has been increased beyond the 120° magnitude depicted in FIG. 4A. In this manner, gap 406 is formed without altering the perfectly rectangular shape of readable tape segments 110I or 110J.

FIG. 5 depicts a front view of the axial surface 18b of the drive sheave shown 18, to which has been affixed a plurality of readable tape segments 110K-R arranged in an octagonal discontinuous pattern 500. As an example, the discontinuous pattern 500 shows all ends of consecutive mounted readable tape segments 110K-R touching one another at joints such as at 502, except that a gap 504 measuring distance d3 is formed between the ends of consecutive readable tape segments 110M and 110N. Many variations of discontinuous pattern 500 are encompassed within the present disclosure. For example, discontinuous pattern 500 can be formed without gaps, with gaps between every consecutive readable tape segment 110K-R, or with more than one such gap but with one or more consecutive readable tape segments 110K-R touching to form a joint such as at 502.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An unintended car movement (UCM) detection system, the UCM detection system installable onto a legacy elevator system in which an elevator car is moveable responsive to rotation of a drive sheave, the UCM detection system comprising:
a plurality of readable tape segments affixed directly to an outer surface of the drive sheave in a discontinuous pattern, each readable tape segment in the discontinuous pattern defining a lower surface adhering to the outer surface of the drive sheave and an upper surface bearing readable information capable of indicating a rotational position of the drive sheave;
a reading sensor positioned in operable proximity to the discontinuous pattern, the reading sensor configured to read the readable information from each of the plurality of readable tape segments in the discontinuous pattern and to transmit read information as rotational data to an output of the reading sensor; and
a logic system configured to operably communicate with the output of the reading sensor and with at least one other component of the legacy elevator system, the at least one other component configurable to send elevator system data to the logic system.

2. The UCM detection system of claim 1, wherein the logic system is further configured to
receive the rotational data from the reading sensor,
receive the elevator system data from the at least one other component of the legacy elevator system,
combine the rotational data with the elevator system data, and
based on a combination of the rotational data with the elevator system data, determine whether the elevator car is undergoing unintended movement.

3. The UCM detection system of claim 2, further comprising a logic system input through which the logic system is configured to receive and monitor an input signal from the reading sensor.

4. The UCM detection system of claim 3,
wherein the logic system input is a first logic system input and wherein the input signal is a first input signal; and
further comprising a second logic system output through which the logic system is configured to receive a second input signal.

5. The UCM detection system of claim 4, wherein the logic system is configured to receive the second input signal from an elevator controller.

6. The UCM detection system of claim 2, further comprising a logic system output through which the logic system is configured to send an output signal to control a braking mechanism.

7. The UCM detection system of claim 6,
wherein the logic system output is a first logic system output and wherein the output signal is a first output signal; and
further comprising a second logic system output through which the logic system is configured to send a second output signal to interrupt one or more circuits within an elevator controller to prevent the elevator car from running electrically.

8. The UCM detection system of claim 1, wherein the outer surface of the drive sheave is a circumferential surface of the drive sheave.

9. The UCM detection system of claim 1, wherein the outer surface of the drive sheave is an axial surface of the drive sheave.

10. The UCM detection system of claim 1, wherein the plurality of readable tape segments comprises a plurality of magnetic tape segments, and wherein the reading sensor comprises a magnetic sensor.

11. A method of detecting unintended car movement (UCM) in a legacy elevator system, the UCM causing rotation of a drive sheave in the legacy elevator system, the method comprising the steps of:
when the drive sheave is in a stationary condition, affixing a plurality of readable tape segments directly to an outer surface of the drive sheave in a discontinuous pattern, each readable tape segment in the discontinuous pattern defining a lower surface adhering to the outer surface of the drive sheave and an upper surface bearing readable information capable of indicating a rotational position of the drive sheave;
positioning a reading sensor in operable proximity to the discontinuous pattern; and
reading, with the reading sensor, the readable information from the discontinuous pattern when the drive sheave rotates.

12. The method of claim 11, further comprising the step of transmitting read information as rotational data to an output of the reading sensor.

13. The method of claim 12, further comprising the steps of:
receiving, with a logic system operably communicating with the output of the reading sensor, the rotational data from the reading sensor;
receiving, with the logic system, elevator system data from at least one other component of the legacy elevator system;
combining, with the logic system, the rotational data and the elevator system data; and
based on a combination of the rotational data with the elevator system data, determining whether an elevator car is undergoing UCM.

14. The method of claim 11, wherein the outer surface of the drive sheave is a circumferential surface of the drive sheave.

15. The method of claim 11, wherein the outer surface of the drive sheave is an axial surface of the drive sheave.

16. The method of claim 11, wherein the plurality of readable tape segments comprises a plurality of magnetic tape segments, and wherein the reading sensor comprises a magnetic sensor.
